(19) United States
(12) Patent Application Publication
(10) Pub. No.: US 2026/0132804 A1
(43) Pub. Date: May 14, 2026

(54) HYDRAULIC POWER TOOL WITH PISTON SEALS

(71) Applicant: Milwaukee Electric Tool Corporation, Brookfield, WI (US)

(72) Inventors: Brandon D. Meister, Brookfield, WI (US); Spencer J. Tiegs, Pewaukee, WI (US); Mathew R. Rentmeester, Wauwatosa, WI (US)

(21) Appl. No.: 19/390,160

(22) Filed: Nov. 14, 2025

Related U.S. Application Data
(60) Provisional application No. 63/720,444, filed on Nov. 14, 2024.

(51) Int. Cl. F15B 15/14; B25B 27/02

(52) U.S. Cl. CPC F15B 15/1452; B25B 27/026

(57) ABSTRACT

A power tool includes a cylinder and a piston movably received in the cylinder. The piston defines a first channel between a first land and a second land, and a second channel between the second land and a third land. A third gap is defined between the third land and the cylinder. The third gap is smaller that each of a first gap between the first land and the cylinder and a second gap between the second land and the cylinder. A first set of seals is disposed within one of the first channel and the second channel. A second set of seals is disposed within the other of the first channel and the second channel. A number of seals in the first set of seals is different than a number of seals in the second set of seals.

### CROSS-REFERNCE TO RELATED APPLICATIONS

This application claims the benefit of and priority to U.S. Provisional Patent Application No. 63/720,444, filed November 14, 2024, which is incorporated herein by reference in its entirety.

### BACKGROUND

Crimpers and cutters often include a crimping head with opposed jaws. Crimpers and cutters may be hydraulic power tools that include a piston that exerts a force on the crimping or cutting head. Hydraulic fluid, including high pressure hydraulic fluid, can be directed in and out of chambers of the actuator to extend or retract the moveable jaw. A piston seal maintains sealing contact between the piston and cylinder bore. The moving piston generates high pressure on the piston seal which increases contact forces between the seal and cylinder surface.

### SUMMARY

The present disclosure provides sealing arrangements for hydraulic pistons that improve sealing while reducing friction and increasing seal longevity. To do so, sets of different numbers of seals and seals of differing materials can be used.

According to one aspect of the present disclosure a power tool can include a cylinder and a piston movably received in the cylinder. The piston can define a first channel between a first land and a second land, and a second channel between the second land and a third land. A third gap is defined between the third land and the cylinder, which is smaller than each of a first gap between the first land and the cylinder and a second gap between the second land and the cylinder. A first set of seals can be disposed within one of the first channel and the second channel. A second set of seals can be disposed within the other of the first channel and the second channel. A number of seals in the first set of seals is different than a number of seals in the second set of seals.

### BRIEF DESCRIPTION OF THE DRAWINGS

The novel features believed characteristic of the illustrative embodiments are set forth in the appended claims. The illustrative embodiments, however, as well as a preferred mode of use, further objectives and descriptions thereof, will best be understood by reference to the following detailed description of one or more illustrative embodiments of the present disclosure when read in conjunction with the accompanying drawings.

FIG. 1 is a perspective view of a hydraulic tool, according to an example embodiment.

FIG. 2 is a block diagram of certain components of the hydraulic tool illustrated in FIG. 1.

FIG. 3 is a side view of a portion of the hydraulic tool illustrated in FIG. 1.

FIG. 4 is a cross-sectional view of the hydraulic tool illustrated in FIG. 1.

FIG. 5 is a detail view of the hydraulic tool of FIG. 1, taken at area V-V of FIG. 4.

FIG. 6 is a detail view of the cylinder and the piston of the hydraulic tool of FIG. 1, taken at area V-V of FIG. 4, with some components removed to show further details of the piston .

FIG. 7 is a detail view of the cylinder and the piston of the hydraulic tool illustrated in FIG. 1, taken at area VII-VII in FIG. 5.

FIG. 8 is a cross-sectional view of a portion of the cylinder and the piston of the hydraulic tool illustrated in FIG. 1, according to another example embodiment.

FIG. 9 is a cross-sectional view of a portion of the cylinder and the piston of hydraulic tool illustrated in FIG. 1, according to another example embodiment.

FIG. 10 is a cross-sectional view of the cylinder and the piston of the hydraulic tool illustrated in FIG. 1, according to another example embodiment.

### DETAILED DESCRIPTION

Hydraulic tools can be used to perform various work operations including, for example, cuts, crimps, punches, presses, etc. Generally, hydraulic tools include a hydraulic actuator that can be extended or retracted to perform a desired work operation. The hydraulic actuator generally includes a cylinder and a piston that moves within the cylinder to move jaws, or any other implement coupled to the piston to perform the work operation.

Hydraulic fluid can be directed in and out of the cylinder to cause the piston to extend and retract. More specifically, hydraulic fluid can be supplied or drained from a working chamber defined by a head of the piston and the walls of the cylinder. To maintain the fluid in the working chamber and prevent leakage past the cylinder head (e.g., into a non-working chamber for single-acting actuators, or a return chamber for double-acting actuators), which would reduce force output, seals are provided on the piston head to seal against the cylinder walls. Similar sealing arrangements can be used in multi-speed piston arrangements and seals can be provided between a first piston and a second piston or another component of the hydraulic actuator.

As such, there is a general need for a hydraulic tool that has durable, effective seals that withstand the pressure in the working chamber, reduce friction, and increase seal life to reduce maintenance. In accordance with examples of the present disclosure, a sealing assembly can include at least two channels on the piston and a plurality of seals disposed on the piston. The number, size, material disposed within a particular channel can be varied to improve sealing while reducing friction and wear. Seal materials can be low-friction polymers, including fluorinated polymers, nitrile polymers, polyketone polymers, or silicon-based polymers. Various combinations of seals comprising different polymeric materials can improve sealing while reducing friction, thereby increasing operating efficiency of the hydraulic actuator.

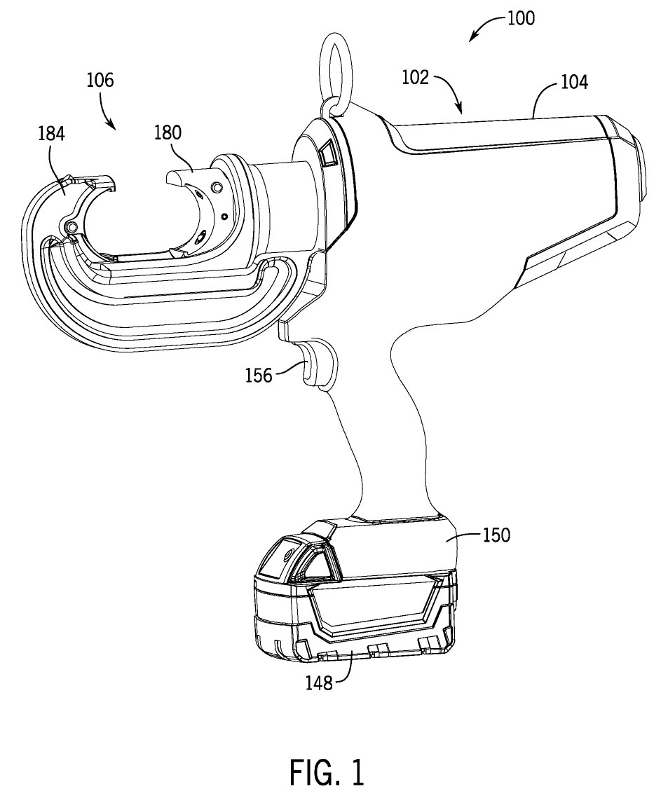

FIG. 1 illustrates certain components of a hydraulic tool 100, in accordance with an example implementation. Although the example implementation described herein references a crimping tool, it should be understood that the features of this disclosure can be implemented in other tools, such as cutting tools or punching tools. In addition, any suitable size, shape or type of elements or materials could be used. As just one example, the illustrated hydraulic tool 100 comprises a housing 104 that houses an actuating system 102 (e.g., a pump, a reservoir or bladder for the hydraulic fluid, motor, cylinder, piston, and electronics, etc.) and a work head 106. The work head 106 can extend from the housing 104 to engage with a workpiece.

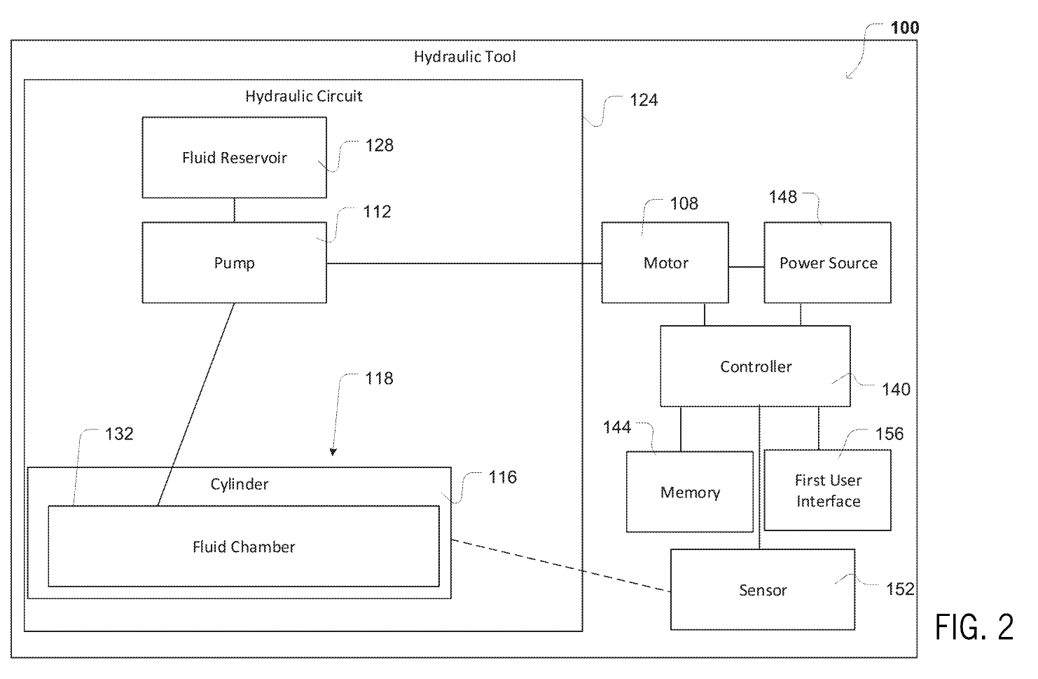

FIG. 2 illustrates a block diagram of the hydraulic tool 100 illustrated in FIGS. 1 and 3-10. As illustrated in FIG. 2, the hydraulic tool 100 includes an electric motor 108 configured to drive a pump 112. The pump 112 is configured to provide pressurized hydraulic fluid to a hydraulic fluid chamber of a hydraulic actuator 118, the hydraulic actuator having a cylinder 116 and a piston 120 moveable within the cylinder 116. For example, a hydraulic circuit 124 of the tool 100 may connect a fluid reservoir 128 to the pump 112, so that the pump 112 may supply fluid to the hydraulic fluid chambers of the actuator 118.

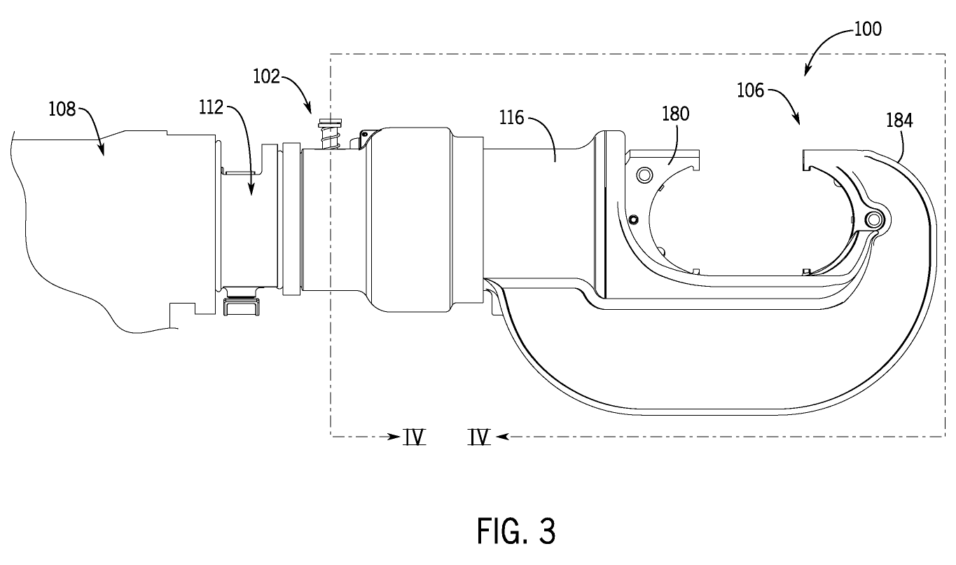

In some examples, certain functions of hydraulic tools can be controlled by a computing device. For example, the hydraulic tool can include a controller 140. The controller 140 may include a processor, a memory 144, and a communication interface. The memory 144 may include instructions that, when executed by the processor, cause the controller 140 to operate the tool 100. In one arrangement, the controller communication interface enables the controller 140 to communicate with various components of the tool 100 such as user interface components, the motor 108, memory 144, a power source 148, sensors 152, and various components of the hydraulic circuit 124 (see, e.g., FIG. 3). The power source 148 may be a battery that may be removably connected to a portion of the hydraulic tool, such as a battery receptacle 150 of the housing 104 of the hydraulic tool.

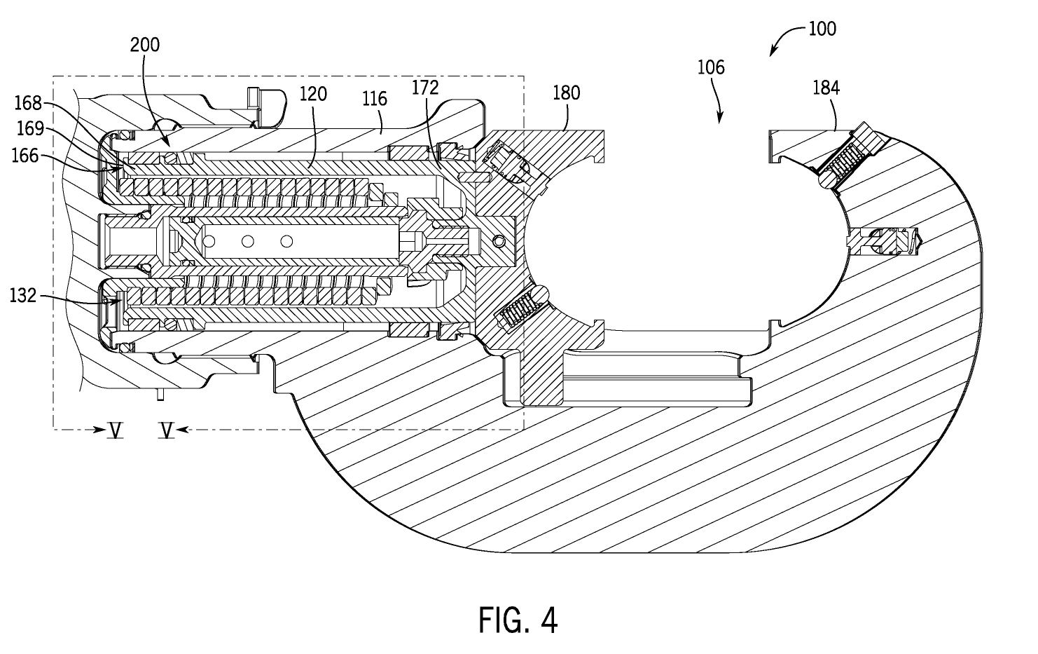

As illustrated in FIG. 1, the hydraulic tool 100 may include a first user interface 156 that allow user inputs to the tool 100. As will be described below, the first user interface 156 may be used to operate functions of the hydraulic tool 100. Specifically, a first user interface component 156 may be actuatable to activate the motor 108 and therefore drive the piston 120 inside the cylinder (see FIG. 4). In some examples, the first user interface component 156 may be linked to the controller 140. For example, the first user interface component 156 can engage a switch coupled to the controller 140. In such examples, actuating the first user interface component 156 may cause the controller 140 to actuate the motor 108. In some cases, a first user interface component 156 may comprise other types of controls for a user, including for example, an operator panel, switches, push buttons, interactive indicating lights, soft touch screens or panels, levers, slides and other types of similar switches such as a trigger switch or trigger as shown in exemplary FIG. 1.

FIG. 3 shows a portion of the tool 100 with a portion of the housing 104 removed for clarity, illustrating the arrangement of the actuating system 102, including the motor 108, the pump 112, the cylinder 116 and the work head 106.

FIG. 4 shows an enlarged cross-sectional view of a portion of the hydraulic tool 100 shown in FIG. 3, providing an example implementation of an actuator arrangement according to aspects of the invention. In this illustrated hydraulic tool, the hydraulic actuator 118 includes a cylinder 116 and a piston 120 movably received in the cylinder 116. The piston 120 of the hydraulic actuator cylinder 116 has a first piston end 168 and a second piston end 172 opposite the first piston end 168. The piston 120 is configured to drive a moveable working head 180 toward a stationary work head 184 to perform a task on a workpiece retained within the work head 106 (e.g., cutting, crimping, punching, or other work). When the piston 120 of the hydraulic actuator cylinder 116 is retracted, the moveable head 180 may be pulled back to a fully retracted or a home position as shown in FIGS. 1 and 4. Alternatively, the moveable head 180 may be pulled back to a partially retracted position.

When pressurized fluid is provided to the cylinder 116 by way of the pump 112, the fluid acts on the piston 120 inside the cylinder 116 and causes the piston 120 to extend toward the workpiece within a work area of the work head 106. Specifically, the pressurized fluid is supplied into the fluid chamber 132 of the cylinder 116, and the fluid may provide a force configured to extend the piston 120. As the piston 120 extends, the moveable working head 180 is moved towards the stationary head 184, and may therefore cause the working heads 180, 184 to act upon a workpiece that has been placed between the working heads 180, 184. When the crimping, cutting, or punching operation is completed, the controller 140 can provide instructions to stop the motor 108 (not shown) and thereby release the high-pressure fluid back to a fluid reservoir (not shown).

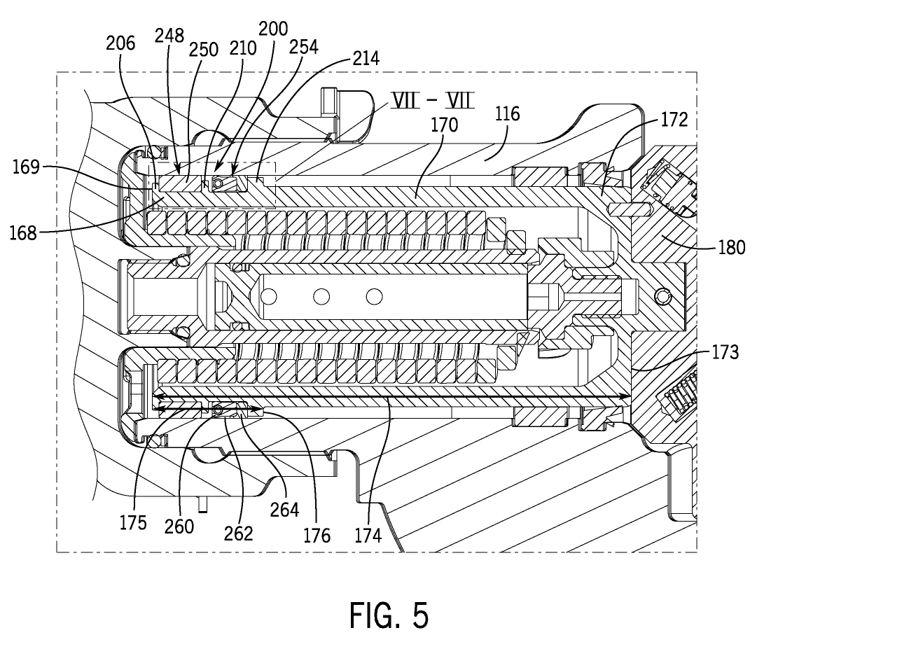

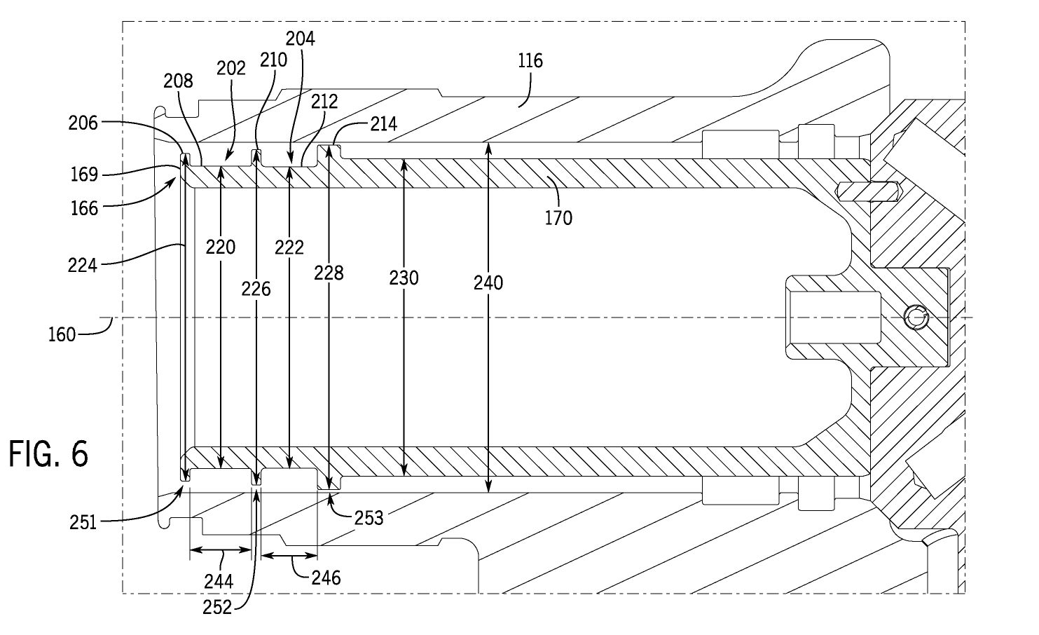

Referring now to FIGS. 5 and 6, as described above, the piston 120 can be moveably accommodated within the cylinder 116. As shown, the piston 120 can include a first piston end 168 and a second piston end 172. The piston 120 includes a piston head 166 that defines a first end 168, and which defines a boundary of the fluid chamber 132. Specifically, the first piston end 168 can have an end surface 169 that is in contact with the hydraulic fluid in the fluid chamber 132. The piston 120 further includes a rod 170 coupled to and extending from the piston head 166. The rod 170 defines a second end 172 of the piston 120 and is configured to couple to the moveable working head 180. The rod 170 can, thus, extend out of the cylinder 116. The piston 120 has a central axis 160. A piston diameter 230 is measured across the central axis 160 of the piston from the outer surface of the piston 120. The piston diameter 230 is less than the cylinder diameter 240 as measured across the central axis 160 to the interior surface of the cylinder 116 to minimize contact and friction therebetween. A piston length 174 is defined as the distance from the first end surface 169 to a second end surface 173.

To prevent fluid from leaking past the piston head 166, the piston head 166 includes a seal assembly 200 (e.g., a seal) that seals against the cylinder 116. Referring to FIGS. 5 and 6, the sealing assembly 200 can include a first channel 202 to receive a first set of seals 248 and a second channel 204 to receive a second set of seals 254. The first channel 202 is positioned between the end surface 169 and the channel 204. The first channel 202 is bounded by a first land 206 and a second land 210, and the second channel 204 is bounded by the second land 210 and a third land 214. The first land 206 extends from the end surface 169 to the first channel 202. The second land 210 extends between the first channel 202 and the second channel 204. The third land 214 extends between the second channel 204 and the rod 170. As shown in FIG. 5, a piston head length 175 is defined from the first end surface 169 to a second end surface 176 of the piston head 166. The rod 170 extend from the second end surface 176 of the piston head 166.

As shown in FIG. 6, the first channel 202 defines a first seal surface 208 as the base of the first channel 202. The second channel 204 defines a second seal surface 212 as the base of the second channel 204. In some examples, the sealing assembly 200 can include more or fewer channels.

Referring still to FIG. 6, the first channel 202 can be configured such that the first seal surface 208 has a first diameter 220. The second seal surface 212 can have a second diameter 222. In some examples, the first diameter 220 can be greater than the second diameter 222. In other examples, the first diameter 220 can be less than the second diameter 222. In some examples, the first diameter 220 is less than the piston diameter 230. In other examples, the second diameter 222 is less than the piston diameter 230.

The first channel 202 can have a first axial length 244. The second channel 204 can have a second axial length 246. The first axial length 244 can be greater than the second axial length 246. In other examples, the first axial length 244 can be less than the second axial length 246. The first axial length 244 can be about the same as the second axial length 246. The sum of the first axial length 244 and the second axial length 246 can be less than 40%, less than 30%, less than 20%, less than 15%, less than 10%, less than 5%, or less than 1% of the piston length 174 (or any range therein, for example, between 27% and 32%, or between 10% and 25%). The sum of the first axial length 244 and the second axial length 246 can be less than 95%, less than 90%, less than 80%, less than 70%, less than 60%, less than 50%, or less than 10% of the piston head length 175, or any range therein (e.g., between 90% and 85% of the piston head length 175). The first channel or the second channel, individually may be less than 80% , less than 70%, less than 60%, less than 50%, less than 40%, less than 30%, or less than 20% of the piston head length 176 (e.g., between 20% and 80% of the piston head length 176).

The first land 206 has an outer surface with a first land diameter 224 relative to the central axis 160. The second land 210 has an outer surface with a second land diameter 226 relative to the central axis 160. In some examples, the first land diameter 224 is less than the second land diameter 226. In other examples, the first land diameter 224 is greater than the second land diameter 226. The first land diameter 224, the second land diameter 226, and third land diameter 228 are selected to be less than the cylinder diameter 240, such that when assembled there are gaps between the interior surface of the cylinder 116 and each of the first land 206, the second land 210, and the third land 214.

The cylinder 116 can be shaped to provide gaps for the various seals, which can provide space to allow the seals to squeeze into when under pressure. The first land diameter 224 can be selected to be less than the cylinder diameter 240, such that when assembled the first land 206 is dimensioned to provide a first gap 251 between the interior surface of the cylinder 116 and the first land 206. The second land diameter 226 can be selected to be less than the cylinder diameter 240, such that when assembled the second land 210 is dimensioned to provide a second gap 252 between the interior surface of the cylinder 116 and the second land 210. The third land diameter 228 can be selected to be less than the cylinder diameter 240, such that when assembled the third land 214 is dimensioned to provide a third gap 253 between the interior surface of the cylinder 116 and the third land 214. Each of the first land diameter 224, second land diameter 226, and third land diameter 228 can be dimensioned such that the first gap 251, second gap 252, and third gap 252 are each a different size. Two or more of the first gap 251, second gap 252, and third gap 253 can be substantially the same size. In some examples, the second gap 252 is larger than the first gap 251, and the first gap 251 is larger than the third gap 253. In other examples, the third gap is smaller than the first gap 251 and the second gap 252. In further examples, the second gap is smaller than the first gap 251 and the third gap 253.

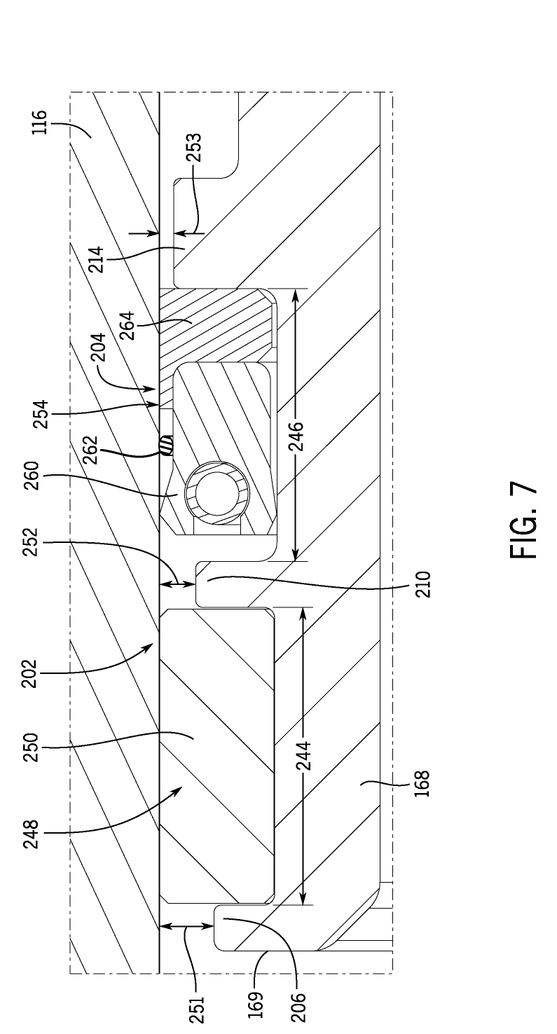

FIG. 7 shows the sealing assembly 200 of FIG. 5. As mentioned above, a first set of seals 248 can be positioned in the first channel 202 and a second set of seals 254 can be positioned in the second channel 204. In some examples, the first set of seals 248 includes a guide band 250, and the second set of seals 254 includes multiple seals. In other examples, the second set of seals 254 includes one, two, or three seals. In some examples, the first set of seals 248 includes multiple seals.

The guide band 250 can be seated in the first channel 202. The guide band encircles the piston 120 and contacts the interior surface of the cylinder 116. The guide band 250 has an axial length that is longer relative to the axial length 244 of the first channel 202 such that it is compressed within the first channel 202. The guide band 250 is dimensioned to form a seal with the interior wall of the cylinder 116 to prevent leakage of hydraulic fluid, for example, the outer diameter of the guide band 250 is larger than the diameter of the cylinder 116, so it is compressed on the interior of the cylinder 116. The extrusion gap 251 formed between the interior wall of the cylinder 116 and the second land 210 helps the guide band 250 form an efficient seal. In operation, gap 252 can be an extrusion gap, where the seal material of guide band 250 can be forced into the gap 252, improving the seal and reducing leakage.

The cross-sectional shape of the guide band 250 can be rectangular as exemplified in FIG. 7. The edge corners of the guide band 250 can be shaped to improve the seal. For example, the edge corners can be square, rounded, notched, or chamfered.

The guide band 250 can be made from a fluorinated polymer material. In some examples the fluorinated polymer material can be polytetrafluoroethylene (PTFE) perfluoroalkoxy (PFA), ethylene tetrafluoroethylene (ETFE), chlorotrifluoroethylene (E-CTFE), or fluorinated ethylene propylene (FEP). These fluorinated polymer materials are wear resistant, have high heat tolerance (operating temperature from about -73°C to about 260°C, or about -100°F to about 500°F), high chemical resistance, and mechanical strength. The fluorinated polymer material provides a low friction contact with the cylinder 116.

As also shown in FIG. 7, the second set of seals 254 can include a first seal 260, a second seal 262, and a third seal 264. The first seal 260 is between the second land 210 and the third seal 264. The second seal 262 is an O-ring compressed between the first seal 260 and the cylinder 116. The third seal 264 is between the first seal 260 and the third land 214.

The second set of seals 254 can be selected to have varying properties and purposes to effectuate sealing while also increasing tool longevity and reducing friction. The first seal 260 can be an O-ring, D-ring, or X-ring. In some examples, the first seal 260 can be a spring seal, where a spring is at least partially enclosed within a polymeric jacket. The first seal 260 can be a shaft seal.

The first seal 260 can include a fluorinated hydrocarbon polymer, polytetrafluoroethylene, an ethylene propylene diene monomer, a nitrile rubber, or a silicone rubber, or another material.

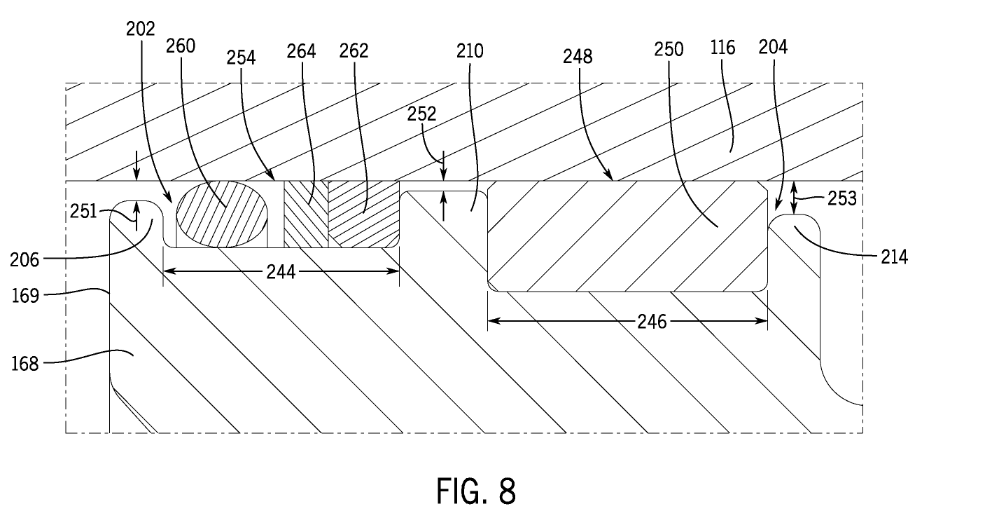

The second seal 262 can be an O-ring. The second seal 262 can be a polyketone seal made of aliphatic polyketone, polyaryletherketone (PAEK or PEK), or polyether ether ketone (PEEK), or another material. Polyketone seals have and advantageous combination of high strength and high modulus as well as chemical resistance and wide range of operating temperature while maintaining mechanical properties (e.g., PEEK range is about -100°F to about 500°F). PEEK seals demonstrate creep resistance, meaning they can sustain large stresses over time without significant extrusion. The second seal 262 can be compressed between the second land 210 and the third seal 264, as shown in FIG. 8.

The third seal 264 can be a seal of any shape made of PTFE, or any other fluorinated polymer, or another material. The third seal 264 can be shaped to receive a portion of another seal. For example, the third seal 264 can have an L-shaped profile as shown in FIG. 7. In some examples, the third seal 264 can have a rectangular profile as shown in FIG. 8.

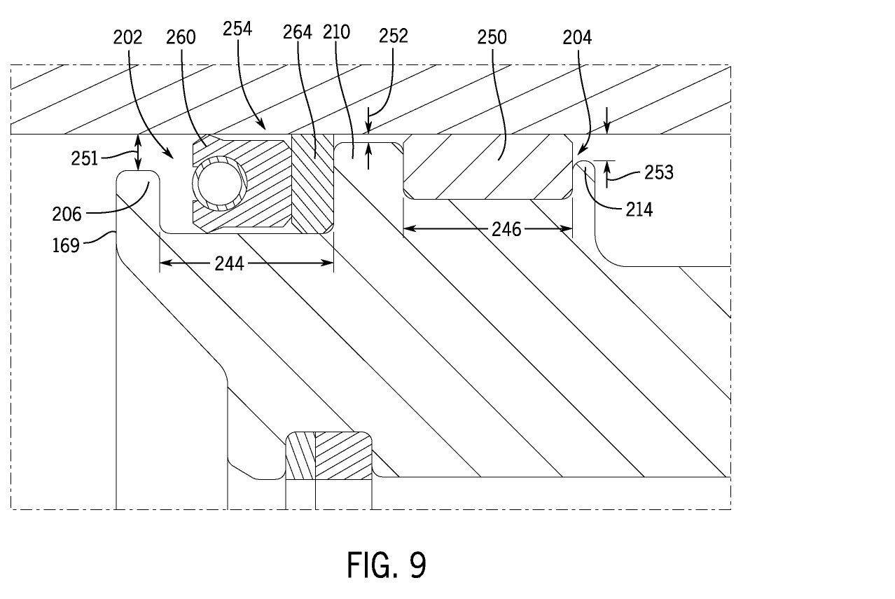

The second seal 262 and third seal 264 can have edge corners that are shaped to reduce friction and wear or prevent damage in use, and for ease of assembly. For example, the edge corners can be square, rounded, notched, or chamfered. For example, the third seal 264 can have a chamfered profile as shown in FIG. 7. In some examples, the portion of the seal proximal to (e.g. the third seal 264 in FIG. 7) or in contact with (e.g. the second seal 262 in FIG. 8) the piston 120 is chamfered. In some examples, the portion of the seal in contact with the cylinder 116 is chamfered (e.g. the first seal 260 and the guide band 250 in FIG. 9).

The sealing assemblies can be arranged in different configurations. For example, in FIG. 8, the first set of seals 248 (e.g., the guide band 250) is seated in the second channel 204 and the second set of seals 254 is arranged in the first channel 202. In this embodiment, the third seal 264 has a rectangular profile and is situated between the second seal 262 and the first seal 260. The first seal 260 is an interchangeable O-ring. The second seal 262 is a polyketone seal. The third seal 264 is made of PTFE. Each of the first seal 260, second seal 262, and third seal 264 are dimensioned such their outer diameters are greater than the piston diameter, ensuring they are compressed between the piston 120 and the interior surface of the cylinder 116.

In this example, the third land diameter 228 is less than each of the first land diameter 224 and second land diameter 226. The second gap 252 between the second land 210 and the interior wall of the cylinder 116 provides an extrusion gap for the guide band 250. Additionally, the third gap 253 between the third land 214 and the interior wall of the cylinder 116 provides an extrusion gap for the guide band 250.

In another embodiment shown in FIG. 9, the guide band 250 is seated in the second channel 204 and the second set of seals 254 is arranged in the first channel 202. In this embodiment, the third seal 264 is situated between the second land 210 and the first seal 260, In this embodiment, seal 264 is made of PTFE and has a rectangular profile. The first seal 260 is a shaft seal or a spring energized seal in this embodiment. In some embodiments, this arrangement of seals can be used with a configuration where the third land diameter 228 is less than each of the first land diameter 224 and second land diameter 226 such that the gap 253 is larger than gap 251 and gap 252, as shown in FIG. 8.

In another embodiment shown in FIG. 9, the guide band 250 is seated in the second channel 204 and the second set of seals 254 is arranged in the first channel 202. In this embodiment, the guide band 250 is situated between the third land 214 and the interchangeable seal, first seal 260, exemplified as a spring energized seal. In this example, the second land diameter 226 is greater than the third land diameter 228. As a result, the second gap 252 and the third gap 253 provide gaps for the guide band 250.

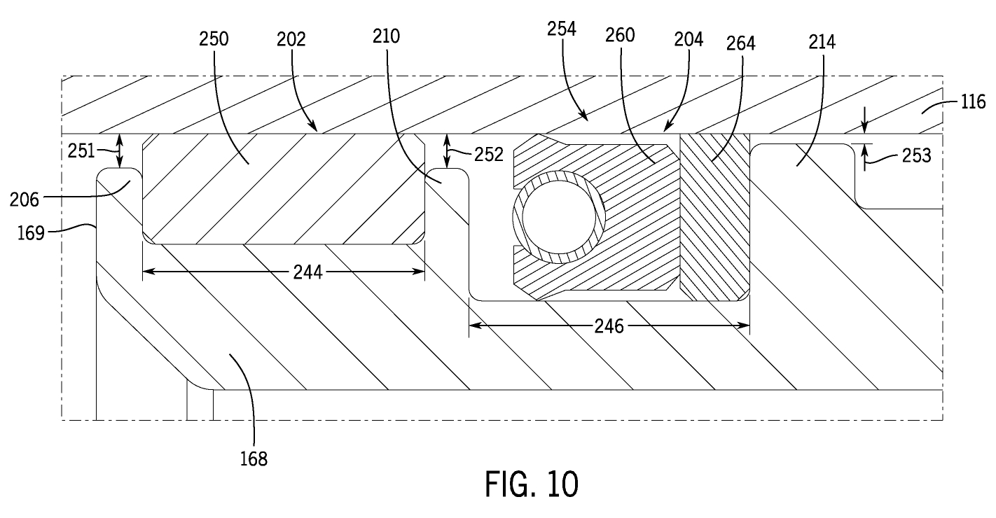

In another embodiment shown in FIG. 10, the guide band 250 is seated in the first channel 202 and the second set of seals 254 is arranged in the second channel 204. In this embodiment, the first seal 260 is situated between the second land 210 and the third seal 264. In this example, the first land diameter 224 and the second land diameter 226 are less than the third land diameter 228. The third land diameter 228 is greater than each of the first land diameter 224 and second land diameter 226 such that the gap 253 is smaller than gap 251 and gap 252. The second gap 252 provides extrusion space for the guide band 250.

In this embodiment the guide band 250 is made of a fluorinated polymer (e.g., PTFE). The first seal 260 is a spring energized seal or shaft seal, including a metal spring or support within an elastomeric jacket. The third seal 264 is made of a fluorinated polymer (e.g., PTFE).

The arrangements of seals as disclosed herein lengthen the life of the tool 100 by reducing wear on the piston by eliminating metal-on-metal contact and reducing leakage of hydraulic fluid.

The following discussion is presented to enable a person skilled in the art to make and use embodiments of the invention. Various modifications to the illustrated embodiments will be readily apparent to those skilled in the art, and the generic principles herein can be applied to other embodiments and applications without departing from embodiments of the invention. Thus, embodiments of the invention are not intended to be limited to embodiments shown, but are to be accorded the widest scope consistent with the principles and features disclosed herein. The following detailed description is to be read with reference to the figures, in which like elements in different figures have like reference numerals. The figures, which are not necessarily to scale, depict selected embodiments and are not intended to limit the scope of embodiments of the invention. Skilled artisans will recognize the examples provided herein have many useful alternatives and fall within the scope of embodiments of the invention.

It is to be understood that the invention is not limited in its application to the details of construction and the arrangement of components set forth in the following description or illustrated in the attached drawings. The invention is capable of other embodiments and of being practiced or of being carried out in various ways. Also, it is to be understood that the phraseology and terminology used herein is for the purpose of description and should not be regarded as limiting. For example, the use of “including,” “comprising,” or “having” and variations thereof herein is meant to encompass the items listed thereafter and equivalents thereof as well as additional items.

In some implementations, devices or systems disclosed herein can be utilized, manufactured, or installed using methods embodying aspects of the invention. Correspondingly, any description herein of particular features, capabilities, or intended purposes of a device or system is generally intended to include disclosure of a method of using such devices for the intended purposes, a method of otherwise implementing such capabilities, a method of manufacturing relevant components of such a device or system (or the device or system as a whole), and a method of installing disclosed (or otherwise known) components to support such purposes or capabilities. Similarly, unless otherwise indicated or limited, discussion herein of any method of manufacturing or using for a particular device or system, including installing the device or system, is intended to inherently include disclosure, as embodiments of the invention, of the utilized features and implemented capabilities of such device or system.

Additionally, unless otherwise specified or limited, the terms “about” and “approximately,” as used herein with respect to a reference value, refer to variations from the reference value of ± 15% or less, inclusive of the endpoints of the range. Similarly, the term “substantially equal” (and the like) as used herein with respect to a reference value refers to variations from the reference value of less than ± 30%, inclusive. Where specified, “substantially” can indicate in particular a variation in one numerical direction relative to a reference value. For example, “substantially less” than a reference value (and the like) indicates a value that is reduced from the reference value by 30% or more, and “substantially more” than a reference value (and the like) indicates a value that is increased from the reference value by 30% or more.

Also as used herein, ordinal numbers are used for convenience of presentation only and are generally presented in an order that corresponds to the order in which particular features are introduced in the relevant discussion. Accordingly, for example, a "first" feature may not necessarily have any required structural or sequential relationship to a "second" feature, and so on. Further, similar features may be referred to in different portions of the discussion by different ordinal numbers. For example, a particular feature may be referred to in some discussion as a "first" feature, while a similar or substantially identical feature may be referred to in other discussion as a "third" feature, and so on.

Also as used herein, unless otherwise limited or specified, “substantially identical” refers to two or more components or systems that are manufactured or used according to the same process and specification, with variation between the components or systems that are within the limitations of acceptable tolerances for the relevant process and specification. For example, two components can be considered to be substantially identical if the components are manufactured according to the same standardized manufacturing steps, with the same materials, and within the same acceptable dimensional tolerances (e.g., as specified for a particular process or product).

The description of the different advantageous embodiments has been presented for purposes of illustration and description and is not intended to be exhaustive or limited to the embodiments in the form disclosed. Many modifications and variations will be apparent to those of ordinary skill in the art. Further, different advantageous embodiments may provide different advantages as compared to other advantageous embodiments. The embodiment or embodiments selected are chosen and described in order to best explain the principles of the embodiments, the practical application, and to enable others of ordinary skill in the art to understand the disclosure for various embodiments with various modifications as are suited to the particular use contemplated.

What is claimed is:

1. A power tool comprising:
a cylinder;
a piston movably received in the cylinder and defining a first channel between a first land and a second land, and a second channel between the second land and a third land, so that a third gap between the third land and the cylinder is smaller than each of a first gap between the first land and the cylinder and a second gap between the second land and the cylinder;
a first set of seals disposed within one of the first channel and the second channel; and
a second set of seals disposed within the other of the first channel and the second channel, a number of seals in the first set of seals being different than a number of seals in the second set of seals.

2. The power tool of claim 1, wherein one of the first set of seals includes a first seal that comprises a fluorinated polymer.

3. The power tool of claim 2, wherein the fluorinated polymer material is selected from the group consisting of polytetrafluoroethylene (PTFE) perfluoroalkoxy (PFA), ethylene tetrafluoroethylene (ETFE), chlorotrifluoroethylene (E-CTFE), and fluorinated ethylene propylene (FEP).

4. The power tool of claim 2, wherein the second set of seals includes a second seal comprising a polyketone.

5. The power tool of claim 4, wherein the polyketone is selected from the group consisting of aliphatic polyketone, polyaryletherketone (PAEK or PEK), and polyether ether ketone (PEEK).

6. The power tool of claim 4, wherein the second set of seals includes a third seal configured as an O-ring and a first seal configured as a spring energized seal.

7. The power tool of claim 2, wherein the cross-sectional shape of the first seal of the first set of seals is rectangular.

8. The power tool of claim 1, wherein a cross-sectional shape of a first seal of the first set of seals is shaped to receive a second seal of the first set of seals, and
wherein a cross-sectional shape of a third seal of the second set of seals is shaped to receive a fourth seal of the second set of seals.

9. The power tool of claim 4, wherein the first gap and the second gap are equal.

10. The power tool of claim 1, wherein the first channel has a first axial length and the second channel has a second axial length, wherein the first axial length and the second axial length are different.

11. The power tool of claim 4, wherein the first set of seals includes a guide band disposed within the first channel and second set of seals disposed within the second channel, wherein the second set of seals includes a first seal configured as a spring energized seal, and a second seal comprising a fluorinated polymer.

12. A power tool comprising:
a cylinder;
a piston having a head at a first end and a rod at a second end, the piston defining a first channel between a first land and a second land, and a second channel between the second land and a third land so that the first channel is between the first end and the second channel, and the piston moveably received in the cylinder so that a second gap between the second land and the cylinder is smaller that each of a first gap between the first land and the cylinder and a third gap between the third land and the cylinder;
a first set of seals disposed within one of the first channel and the second channel; and
a second set of seals disposed within the other of the first channel and the second channel, a number of seals in the first set of seals being different than a number of seals in the second set of seals.

13. The power tool of claim 12, wherein one of the first set of seals comprises a fluorinated polymer.

14. The power tool of claim 12, wherein the second set of seals comprises a first seal, a second seal wherein the first seal is configured as a spring seal and the second seal is an O-ring.

15. The power tool of claim 14, wherein the first seal is arranged between the first land and the second seal, the second seal is arranged between the first seal and a third seal, and the third seal is arranged between the second seal and the second land, wherein the third seal comprises a fluorinated polymer.

16. The power tool of claim 14, wherein the second seal of the second set of seals comprises a polyketone.

17. The power tool of claim 14, wherein the first seal is disposed between the first land and a third seal, wherein the third seal comprises a fluorinated polymer.

18. The power tool of claim 12, wherein second set of seals is disposed within the first channel, the first gap is smaller than the third gap and the second set of seals includes a first seal that is an O-ring disposed between the first land and the second seal, the second seal is disposed between the first seal and the third seal, and the third seal is disposed between the second seal and the second land,
wherein the first seal is selected from a fluorinated hydrocarbon polymer, polytetrafluoroethylene, an ethylene propylene diene monomer, a nitrile rubber, or a silicone rubber, the second seal is a polyketone seal selected from aliphatic polyketone, polyaryletherketone or polyether ether ketone, and the third seal is a fluorinated polymer.

19. The power tool of claim 12, wherein the first channel has a first axial length and the second channel has a second axial length, wherein the sum of the first axial length and the second axial length is less than 20% of a length of the piston.

20. A hydraulic actuator for a handheld power tool, the actuator comprising:
a cylinder defining an axis;
a piston including:
a rod;
a head defining a head length along the axis between a first end and a second end opposite the first end, the second end coupled to the rod, the head further defining a first channel between a first land at the first end of the head and a second land, and a second channel between the second land and a third land at the second end of the head,
the head received in the cylinder so that at least two of a first gap between the first land and the cylinder, a second gap between the second land and the cylinder, and a third gap between the third land and the cylinder are a different radial size relative to the axis;
a single seal disposed within the first channel and comprising a fluorinated polymer; and
a second set of seals disposed within the second channel, the second set of seals including a first seal configured as a spring seal disposed between the second land and a third seal, the third seal disposed between the first seal and the third land, and a second seal disposed between the first seal and the third seal.
